(19) United States
(12) Patent Application Publication
(10) Pub. No.: US 2018/0075014 A1
(43) Pub. Date: Mar. 15, 2018

(54) CONVERSATIONAL ARTIFICIAL INTELLIGENCE SYSTEM AND METHOD USING ADVANCED LANGUAGE ELEMENTS

(71) Applicant: Xiaojiang Duan, Beijing (CN)

(72) Inventor: Xiaojiang Duan, Beijing (CN)

(21) Appl. No.: 15/261,947

(22) Filed: Sep. 11, 2016

(51) Int. Cl. G06F 17/27; H04L 12/58; G06N 3/00; G06N 99/00

(52) U.S. Cl. CPC G06F 17/279; H04L 51/02; H04L 51/04; G06N 3/006; G06N 99/005; G06F 17/271

(57) ABSTRACT

A chatbot system and method using advance conversation language elements. The method employs a chatbot having a processor, an interactive dialog interface, and a knowledge database. Among other elements or steps, the method receives through the interactive dialog interface one or more characters of a user input message. In response to the user input message, the chatbot processor is used to generate an output message that is based one or more extension language elements. The language element may be such that the output message is processed only 1) when the at least one or more characters of the user input message can be no more than either numeric text or words that can be converted to numeric text, or 2) if priority of context after the user input message can be dynamically increased or decreased on the fly. It may also be that the output message is processed only when one or more characters of the user input message can be no more than a predetermined number of words.

### BACKGROUND

The present disclosure relates generally to chatbot systems and methods, and more specifically to candidate message chatbot systems and methods.

Chatbots are designed to simulate an intelligent conversation with one or more human users via auditory or textual methods. Chatbots often include a knowledge base and a set of algorithms enabling users to submit input messages to the chatbot. The knowledge base entries attempt to match the user input message with corresponding patterns for chatbot response.

An interactive dialog, known as a chat session, often occurs when a user submits a first input message to a chatbot. Upon receipt of the input message, the chatbot matches the input message with an input pattern in its knowledge base having a corresponding output response. Thereafter, the chatbot generates and displays the output response to the user.

Users and chatbot creators alike are continuously improving the performance and productivity of existing chatbot systems to enable continuous chat interaction between users and chatbots even when such interactive chat becomes more advanced and complex.

It is within the above context that a need for the present disclosure has arisen. The present disclosure meets this need to address one or more disadvantages of conventional systems and methods.

### BRIEF SUMMARY

Various aspects of a chatbot system and method that uses advanced conversational language elements can be found in exemplary embodiments of the present disclosure.

In a first embodiment, a method, operable by a chatbot having a processor, an interactive dialog interface, and a knowledge database based at least in part on one or more language elements is disclosed. In one embodiment, the language elements are extensions of AIML (Artificial Intelligence Markup Language). The language elements may also be extensions of other known markup languages or may used independently.

Among other elements or steps, the method receives through the interactive dialog interface one or more characters of a user input message. In response to the user input message, the chatbot processor is used to generate an output message that is based one or more language elements, which may be extensions of AIML.

In one embodiment, the output message is processed only a) when the at least one or more characters of the user input message can be no more than either numeric text or words that can be converted to numeric text, or b) if priority of context after the user input message can be dynamically increased or decreased on the fly.

In another embodiment, the output message is processed only when the at least one or more characters of the user input message can be no more than a predetermined number of words.

In a further embodiment, the output message is processed only if previously returned indexes are excluded from being candidates for random output messages provided in response to the user input message. Further yet, in another embodiment, the wherein for a list of items, each of which is to be returned from an ordered list, the output message is processed only if a pointer is automatically created and maintained for the ordered list to sequentially return each item in the ordered list.

In another embodiment, the output message is processed only if the ordered list can be named and a pointer is automatically maintained for the ordered list. Further yet, in an embodiment, the output message is processed only if the input message includes a wildcard element which can be marked to track frequency of use content with the wildcard element.

In another embodiment, the output message is processed only if a separate processor instance is used for mapping one set of strings to another set. Yet, in one embodiment, the output message is processed by a separate processor instance. In an embodiment, the output message is processed by a separate processor instance.

A further understanding of the nature and advantages of the present disclosure herein may be realized by reference to the remaining portions of the specifications and the attached drawings. Further features and advantages of the present disclosure as well as the structure and operation of various embodiments of the present disclosure are described in detail below with respect to the accompanying drawings. In the drawings, the same reference numbers indicate identical or functionally similar elements.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 illustrates a chatbot communication system according to an exemplary embodiment of the present disclosure.

FIG. 2A shows a cell and a chatbot dialog interface of the chatbot system of FIG. 1 to illustrate the Wildcard (*) Number language element in accordance with an exemplary embodiment of the present disclosure.

FIG. 2B shows a cell and a chatbot dialog interface of the chatbot system of FIG. 1 to illustrate the Wildcard (*) Word language element in accordance with an exemplary embodiment of the present disclosure.

FIG. 3 shows a cell and the chatbot dialog interface of the chatbot system of FIG. 1 to illustrate the Set Context language element in accordance with an exemplary embodiment of the present disclosure.

FIG. 4 shows a cell and chatbot dialog interfaces of the chatbot system of FIG. 1 that illustrate the Random “Rand” language element in accordance with an exemplary embodiment of the present disclosure.

FIG. 5 shows a cell and a chatbot dialog interface of the chatbot system of FIG. 1 that illustrate the Weak element in accordance with an exemplary embodiment of the present disclosure.

FIG. 6 shows a cell and chatbot dialog interfaces of the chatbot system of FIG. 1 that illustrate the List element in accordance with an exemplary embodiment of the present disclosure.

FIG. 7 shows a cell and chatbot dialog interfaces of the chatbot system of FIG. 1 that illustrate the Loop element in accordance with an exemplary embodiment of the present disclosure.

### DETAILED DESCRIPTION

Reference will now be made in detail to the embodiments of the disclosure, examples of which are illustrated in the accompanying drawings. While the disclosure will be described in conjunction with the preferred embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth to provide a thorough understanding of the present disclosure. However, it will be obvious to one of ordinary skill in the art that the present disclosure may be practiced without these specific details. In other instances, well-known methods, procedures, components, and circuits have not been described in detail so as to not unnecessarily obscure aspects of the present disclosure.

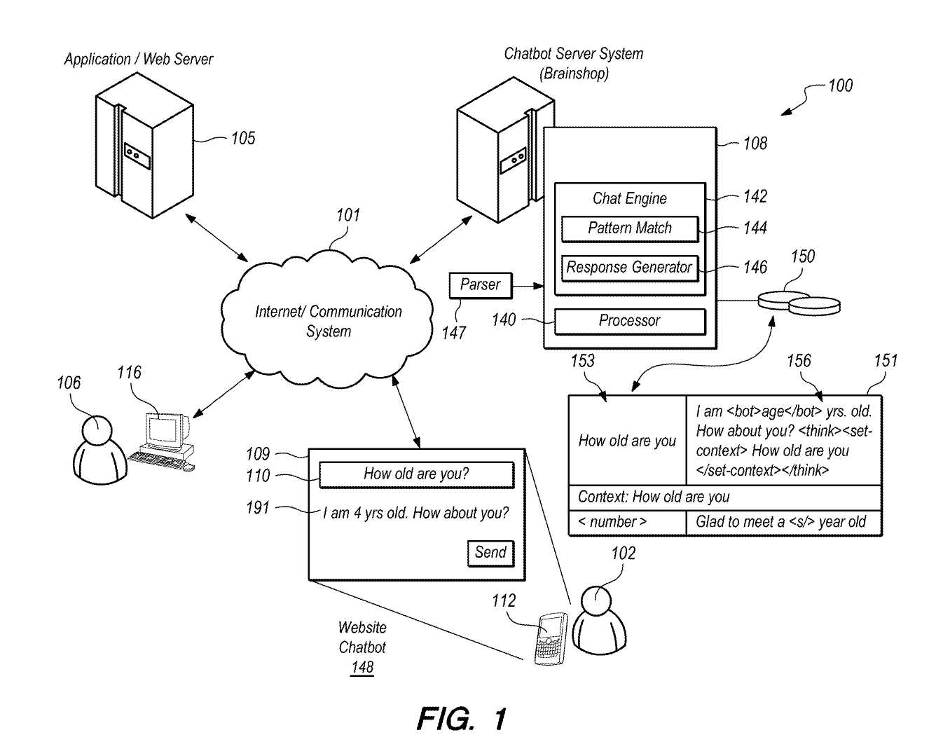

FIG. 1 illustrates chatbot communication system 100 according to an exemplary embodiment of the present disclosure.

Here, chatbot communication system 100 might include user 102 operatively coupled to chatbot server system 108 via Internet 101. Here, Internet 101 represents any distributed network (wired, wireless or otherwise) for data transmission and receipt between/among two or more points. In some embodiments, chatbot server system 108 includes a graphical image, including, without limitation, an avatar, a talking head, a text-to-speech engine, etc. Although not shown, chatbot server system 108 might be installed on a stand-alone computer without need for a computer network.

Specifically, user 102 is operatively coupled to chatbot server system 108 via application/web server 105. In this example, user 102 represents a customer shopping on a website (not shown) that is hosted by application/web server 105. The website might include website chatbot 148 that is deployed on the website to engage user 102 and other shoppers. Website chatbot 148 is deployed on application/web server 105, but communicates with chatbot server system via an API (Application Programming Interface).

As shown in FIG. 1, user 102 utilizes mobile device 112 to communicate with website chatbot 148 and chatbot server system 108. Mobile device 112 is a portable communication device such as a smart phone and the like. In one embodiment, the communication with chatbot server system 108 can occur via website chatbot 148 and chatbot dialog interface that are hosted by application/web server 105. User 102 essentially uses a browser (not shown) and chatbot dialog interface 109 of website chatbot 148 to interact with chatbot server system 108.

In FIG. 1, chatbot communication system 100 also includes merchant 106. Merchant 106 is the creator or owner of the website chatbot 148. Initially, merchant 106 uses desktop computing device 116 to directly chatbot server system 108 in order to create a chatbot. No programming experience is required as the web interface for chatbot server system can create all of the requisite programming and templates for the chatbot. As further discussed below, in one embodiment, the programming language for the chatbot is based at least in part on language elements that are extensions of AIML (Artificial Intelligence Mark Up Language).

After creation of the chatbot, merchant 106 then uses the web interface to train the chatbot to respond as needed based upon the environment in which the chatbot is to be deployed. After training the chatbot, merchant 106 then utilizes the API to deploy the chatbot on application/web server 105, the chatbot being deployed as website chatbot 148.

As shown, website chatbot 148 includes chatbot dialog interface 109. During a chat session user 102 may submit a question “How old are you?” as shown at 191 and in response, the chatbot may display an output message “I am 4 yrs old. How about you?” as shown as 110. This interaction can continue until the user's inquiry is satisfied.

Chatbot output messages are generated by chatbot server system 108 by querying the knowledge base for patterns corresponding to user input messages according to a set of language elements. Unlike traditional chatbot systems, in one embodiment, the present disclosure may be based in part on at least language elements that are extensions of AIML. Chatbot server system 108 further includes knowledge database 150 that stores language element templates.

Specifically, knowledge database 150 includes a data structure, node or cell 151 having an input pattern 153 and a corresponding output template 155. Input pattern 153 might include the conditional wildcard number with syntax <number> which in one embodiment is a language element that is an extension of AIML.

In FIG. 1, chatbot server system 108 further includes chat engine 142 having pattern matcher 144, response generator 146 and parser 147, processor 144 which might also represent one or more instances of additional processing.

In operation, briefly, when user 102 submits an input message “How old are you?” as shown in dialog box 110, chat engine 142 processes the message to generate a corresponding output message “I am 4 yrs old. How about you?” Specifically, chat engine 142 utilizes a parser 147 to parse the incoming input message from user 102 to generate an identifiable pattern. Thereafter, pattern matching engine 144 recognizes the pattern and matches that to input pattern 153, which is itself based on extension of AIML language elements. Output template 155 (also based in part on AIML language elements in one embodiment) which is paired with input pattern 153 is then used by response generator 146 to generate the output message “I am 4 yrs old. How about you?” as shown in chatbot output display 199.

Many components of chatbot communication system 100 and chatbot server system 108 have been omitted to avoid unnecessarily complicating the description of the disclosure. One skilled in the art will realize that the aforementioned systems may comprise more or less components as needed to implement the present disclosure.

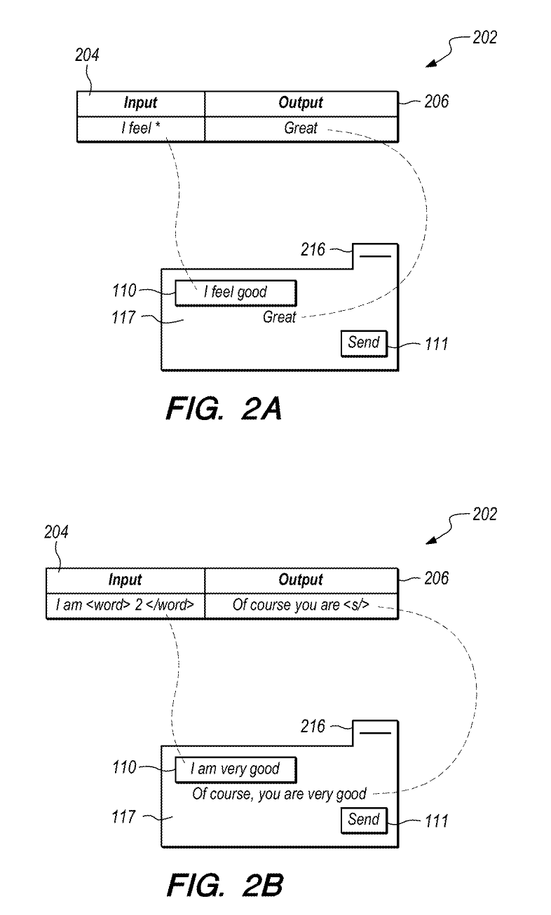

FIG. 2A shows cell 202 and chatbot dialog interface 216 of chatbot server system 108 (FIG. 1) to illustrate the Wildcard (*) Number language element in accordance with an exemplary embodiment of the present disclosure.

Specifically, in FIG. 2A, cell 202 and chatbot dialog interface 216 illustrate an instance of Wildcard (*) Number. Wildcard (*) Number is itself a language element extension of AIML. Specifically, Wildcard (*) Number is a conditional wildcard that has the syntax <number/>. Unlike conventional wildcards that simply represent any one or more words in input, Wildcard (*) Number extends the traditional language element with specific conditions.

For example, once such condition is that Wildcard (*) Number is word that can represent a number. Examples of words are one, two, ten, fourteen, 15, 35, 220, etc. Wildcard (*) Number can also be used to set a range of numbers for the wildcard. The range of numbers may be between one and five numbers, for example.

Referring now to FIG. 2A, cell 202 includes input 204 and output 206 that are stored in knowledge database 150. Input 204 represents the pattern to which a user input is matched while output 204 represents the corresponding template output for input 204. As shown here, in input 204, the pattern “I am <number>” is stored. Here, <number> represents the number wildcard. Output 206 of cell 202 stores the template “I am so glad to meet a <s/> year old.” The <s/> language element in output 206 returns the number represented by the wildcard.

In FIG. 2A, upon beginning a chat with chatbot server system 108, user 102 enters “I am 17” into dialog box 110 and then selects send button 111 to submit his or her input. Responsive thereof, chatbot server system 108 returns the response “I am so glad to meet a 17 year old” as shown at chatbot output display 117.

In operation, here, “17” in input 204 represents the wildcard number. In accordance with an embodiment, a software program or function is provided that determines whether the wildcard number is numeric or can be converted to a number. The function returns TRUE if the wildcard number is either numeric or can be converted to a number. In this case, the wildcard number “17” is numeric, the function returns TRUE so that the input 204 pattern and the user's input “I am 17” are matched. The corresponding output 206 “I am so glad to meet a 17 year old” is then generated as shown at chatbot output display 117.

FIG. 2B shows cell 202 and chatbot dialog interface 216 of chatbot server system 108 to illustrate the Wildcard (*) Word language element in accordance with an exemplary embodiment of the present disclosure.

The Wildcard (*) Word language element requires that the wildcard represent no more than a specific number of words. For example, the wildcard may be for one, two, five, etc. words, for example. This language element also allows users to specify a range of number of words such one to three words, for example.

The syntax for the Wildcard (*) Word language element is:

<word>number</word>

Here, the parameter “number” is the number of words for the wildcard. In one embodiment, the number of words is an integer from one to five. If this parameter is omitted or invalid, the default number is one. That is, the syntax becomes: <word>1</word>.

Referring now to FIG. 2B, in input 204, the pattern “I am <word>2 </word>” is stored. Here,“2” represents the number of words represented by the wildcard. Output 206 of cell 202 stores the template “Of course, you are <s/>.”

In FIG. 2B, upon beginning a chat with chatbot server system 108, user 102 enters “I am very good” into dialog box 110 and then selects send button 111 to submit his or her input. Responsive thereof, chatbot server system 108 returns the response “Of course, you are very good” as shown at chatbot output display 117.

In operation, here, “2” in input 204 sets the specific number of words represented by the wildcard. A software program or function is provided that counts the words of given text that represents the wildcard in input 204. The function returns TRUE if the word count matches the given criteria, here “2.” Here, there are two words “very” and “good” in the user's entry in dialog box 110, thus the input 204 pattern and the user's input are matched. The corresponding output 206 “Of course, you are very good” is then generated as shown at chatbot output display 117. An advantage of the language element is that chatbot responses are more natural as such responses are more specifically tailored to user inputs, unlike traditional systems that match any word without additional conditions.

As another example, a traditional system will have an input and corresponding output as follows:

Input: I am *
Output: Thank you for telling me that.

An embodiment of the present disclosure can be similar and can return a more tailored (and more natural) response “I am so glad to me a <s/>year old” below.

Input: I am *
Output: Thank you for telling me that.
Input: I am <number/>
Output: I am so glad to meet a <s/> year old.

An alternative syntax for Wildcard (*) Word is:

<word>start, end</word

The parameters “start, end” represent the range of words that can be represented by the wildcard. In one embodiment, “start” is an integer from one to five while “end” is also an integer from one to five. In this embodiment, “start” is also less than “end.”

The syntax for Wildcard (*) Word can also be: <word/>. In such a case, the input template might be “I feel <word>” while the output template is “Great.” As an example, a user input might be “I feel good” and the corresponding chatbot output might be “great.”

Processing Wildcard with AI Instance: In this embodiment, the conditional wildcards—Wildcard (*) Number and Word—described above, have their conditions processed by another AI instance other than the current one. That is a separate AI instance is used as a condition processor. This element can be taken as a special conditional wildcard that uses the AI instance to replace the above function for checking conditions. In operation, a software program that creates one or more named AI instances (other than the current AI instance) is employed. The system then feeds candidate text (e.g. from dialog box 110) to the AI instance. If the AI instance returns TRUE, the candidate text and the input (204 pattern) are matched. The AI instances can also recursively invoke another AI for additional advanced functionalities.

AI based Converter: Unlike traditional system the uses a text list for mapping, this language element in one embodiment uses an AI instance to define the map from a string to another. For example a country/capital converter consists a list of country names and corresponding capital city name like: USA/Washington D.C., China/Beijing, etc. An advantage of this embodiment is that conversion rules can be based on not only a list of text pair but also the language elements that AI engine supports.

In operation, an AI instance is created; a software program is provided that allows the user to define a converter and associate the AI instance with the converter. AI instance is named after the name of Converter and is referred with its name. A set of AI content items define how the conversion should be done. Alternatively, a program that allows users to create their own contents for converter AI is may be provided. A program that parses the Converter element and get its input parameter may be provided. A program that feeds the input to the corresponding AI, gets an output from the AI and returns it.

Nerve: is a simplified element that creates the separate instance on which wildcard processing and conversion described with reference to paragraphs 55 and 56 can be based. Nerve consists of one or more neurons or simplified cells that can use other language elements. While other language elements do not require a separate AI instance as such language elements can be executed directly. Nerve creates a separate instance that receives parameters from the main processing program and returns the results. Nerve which is represented by “n” may be for the input or output. When used as input, “n” is given by:

[59]<n> nerve <n/>

where “nerve” is the name of the nerve. The name of the nerve may be “color” for example (see below). The n element can be considered a wildcard (*) except that the n element represents words that are defined by the system nerve or represents values other than <null/> that are returned by the system nerve.

Example—representing a string defined by system nerve—

Nerve: color

> red
> blue
> green

Cell

| | |
|---|---|
| Input => | I like <n>color</n> |
| Output <= | <s/> is a beautiful color. |

Log

| | |
|---|---|
| User input: | I like blue. |
| Bot output: | Blue is a beautiful color |

When used as output “n” is given by:

<n>nerve(expression)</n>

where “nerve” is the name of the nerve to apply. The name of the nerve may be “city2country” for example (see below). The nerve(expression) is first calculated; the result of the calculation is then provided to nerve as an argument. The nerve's results are return to output field. If nerve doesn't define how to process the input text, the text is returned as is.

Example—returning country by city

Nerve: city2country

>New York
>USA

Cell

| | |
|---|---|
| Input => | I am from * |
| Output <= | Glad to meet someone form |

<n>city2country(<s/>)</n>!

Log 1

| | |
|---|---|
| User input: | I am from New York. |
| Bot output: | Glad to meet someone from USA! |

Log 2

| | |
|---|---|
| User input: | I am from Austin |
| User output: | Glad to meet someone from Austin! |

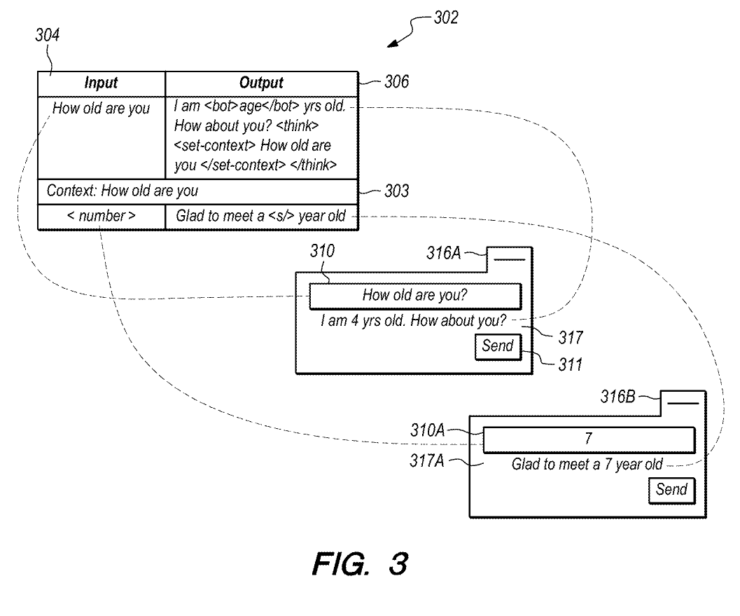

FIG. 3 shows cell 302 and chatbot dialog interfaces 316A and 316B of chatbot server system 108 (FIG. 1) to illustrate the Set Context language element in accordance with an exemplary embodiment of the present disclosure.

Specifically, in FIG. 3, cell 302 and chatbot dialog interface 316A and 316B illustrate an instance of Set Context language element, which in one embodiment is a language element extension of AIML. Set Context is a dynamic context language element with a syntax <set-context>expression</set-context>. This syntax returns “expression” for the current robot message and sets the expression as context for the next user message. By default the chatbot system sets the last sentence of the chatbot message as context.

Unlike conventional wildcards that set the message or one of the sentences previously returned by chatbot as context for the current input, the Set Context language element of the present disclosure allows users to set any text as context for the next input. In fact, when used with the Think element, a user can also set text that is not included in the chatbot output message as the next context.

In FIG. 3, cell 302 includes input 304 and output 306 that are stored in knowledge database 150. A further cell 303 that contains the context data is also stored in knowledge database 150.

As shown for cell 302, input 304, the pattern “How old are you” is stored. Output 306 of cell 302 stores the template “I am <bot>age</bot> yrs old. How about you ? <think><set-context>How old are you</set-context></think>.” For cell 303, the pattern <number> is stored as input 304 and “Glad to meet a <s/> year old” is stored in as output 306.

Referring now to FIG. 3, during a chat with chatbot server system 108, user 102 or 106 is asking the chatbot “How old are you?” as shown in dialog box 310 and then selects send button 311 to submit this question. In response, chatbot server system 108 returns the response “I am 4 yrs old. How about you?” as shown at chatbot output display 317. The user answers the question by entering “7” as his or her age as shown in dialog box 310A. Responsive thereof, the chatbot says: “Glad to meet a 7 year old” as shown in chatbot output display 317A.

In operation, when the chatbot dialog interface 316A receives the question “How old are you?” from dialog box 310, chatbot server system 108 matches the pattern with input 304, which is paired with output 306 template. Here, a context software application determines whether the output 306 contains the Set Context element.

If yes, the context software program sets the text within the element as the context for the next end user message. In this case, output 306 includes: set-context>How old are you</set-context> where the text within the set context element is “How old are you.” Thus, the question “How old are you” is then used as the context for the next end user message, namely “7” as shown in dialog box 310A.

Note that this context for “How old are you” is stored in cell 303. Thus, the next user input “7” is matched with <number> input of cell 303, which is paired with output 306 “Glad to meet a <s/> year old.” This output 306 then generates the chatbot response “Glad to meet a 7 year old” as shown in chatbot output display 317A.

Strong Context: This language element allows a user to increase the priority of context on the fly by including the language element in the context field. The syntax is: <strong/>expression. Without the strong element in the context field, the cell is of “normal context,” which means the context is processed after input. With the strong element in the context field, the cell is considered “strong context” so that the context is processed before input.

Normal Context: This element resets the strong context and continues the process with a normal context. The normal context becomes effective from the next cell. The syntax is: <normal-context/>. If there is no strong context, normal-context is ignored and is inconsequential. After a content item has increased the priority of context, another item may change it back to the lower one. It is noted that this element doesn't clear the context, it simply changes the mode of the context.

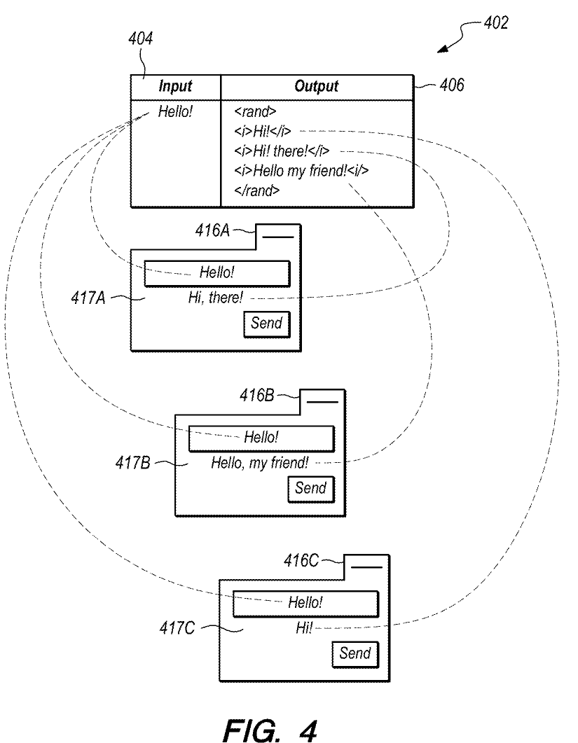

FIG. 4 shows cell 402 and chatbot dialog interfaces 416A, 416B and 416C of chatbot server system 108 (FIG. 1) that illustrate the Random “Rand” language element in accordance with an exemplary embodiment of the present disclosure.

Specifically, in FIG. 4, cell 402 and chatbot dialog interfaces 416A, 416B and 416C illustrate an instance of Rand, which in one embodiment is a language element extension of AIML. This element returns a random item from a set. This disclosure improves user experience by storing previously returned indexes and excluding them from the candidates for display. When all of the numbers in the range are used, the system clears the storage and starts over. Optionally, the system may keep one or more latest indexes when clearing the storage. This results in very “random” behavior to end users.

However, traditional systems use pseudo-random number serials for random behavior. From a user perspective, the behavior of such pseudo-random or real random numbers is not random but repetitive. Assume there is a list of 5 questions, to return a random question from the list, traditional systems might use a pseudo-random number serial: 3, 1, 1, 2, 5, 3, . . . . In this example, end users will feel there is a duplicate when the system asks them the first question twice.

The syntax for Random “Rand” as further illustrated by FIG. 4 is as follows:

```
<rand>
  <i>item 1</i>
  <i>item 2</i>
```

<i>...</i>

</rand>

Where item 1, item 2, etc. are expressions that can only be returned once.

Referring now to FIG. 4, cell 402 includes input 404 and output 406 that are stored in knowledge database 150. Input 404 stores the pattern “Hello!” Output 406 stores the corresponding template having several candidate responses within the <rand> and </rand> language elements. As shown, the candidate responses are “Hi” as shown in chatbot dialog interface 416C, “Hi, there!” as shown in chatbot dialog interface 416A and “Hello my friend!” as shown in chatbot dialog interface 416B.

In operation, when the chatbot dialog interface 416A receives the greeting “Hello!” via dialog box 410A, chatbot server system 108 matches the pattern with input 404, which is paired with output 406 template. Next, a (pseudo-) random number generator or program is used to return the responsive greeting “Hi, there!” as shown at 417A.

An identification number is assigned and recorded for the returned item (Hi, there!). This returned item is then excluded from future candidates. If no candidates are available (all items are returned), the program reset the IDs for return items (optionally may keep one or more last IDs) and recalculate the candidates.

Hence, when the user again enters “Hello!” via dialog box 416B, there are only two response candidates namely “Hi!” and “Hello my friend!” from output 406. As shown by chatbot dialog interface 416B, the pseudo-random number selects “Hello my friend!” displayed in 417B. “Hello my friend!” is now assigned a user ID and then excluded from the next iteration. When the user again enters “Hello!” via dialog box 416C, one response candidate “Hi!” remains that is selectable from output 406. As shown by chatbot dialog interface 416C, the pseudo-random number selects “Hi” displayed in 417C.

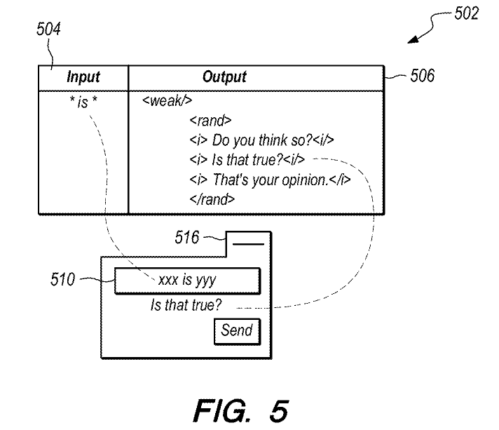

FIG. 5 shows cell 502 and chatbot dialog interface 516 of chatbot server system 108 (FIG. 1) that illustrates the Weak element in accordance with an exemplary embodiment of the present disclosure. The Weak element works in conjunction with Discovery which presents data generated by the Weak element.

In FIG. 5, cell 502 and chatbot dialog interface 516 illustrate an instance of the Weak language element, which in one embodiment is an extension of AIML. This Weak element is configured to mark a cell as “weak” cell and to include the cell within a Discovery report. Weak cells are those with inputs that contain one or more stars (*); the output of such cells cannot provide exact answers. Where a cell's output field includes a <weak/> element, a record is created each time the cell is used. By reviewing such records, one can markedly improve chatbot efficiency.

Traditional systems do not enable users to understand usage of a specific content item. This disclosure allows users to use a Weak element to mark content items and then use Discovery to view the use frequency and end user messages matched for each content item. This is particularly useful to analyze the usage of content items with wildcards, which typically cannot give exact replies.

The syntax for the Weak element is <weak/>. Referring now to FIG. 5, cell 502 includes input 504 and output 506 that are stored in knowledge database 150. Input 504 stores the pattern “* is *” while output 506 stores the corresponding template:

<weak/>

<rand>

<i>Do you think so?</i>
<i>Is that true?</i>
<i>That's your opinion.</i>

</rand>

As shown in chatbot dialog interface 516, the user input message to the chatbot is “xxx is yyy” as shown in dialog box 510 to which the chatbot responds “Is that true?” as shown in chatbot output display 517.

In operation, when the chatbot dialog interface 516 receives the statement “xxx is yyy” via dialog box 510, chatbot server system 108 matches the pattern with input 504, which is paired with output 506 template. Here, an application is provided that obtains the statement “xxx is yyy” and optionally normalizes the message by removing points and/or applying consist caps. The application then checks the message against the records of previously captured messages to see if the message has been provided previously as a response. If it exists, increase its count by one. Otherwise, a new record is added and the count set to one. As previously noted, among other advantages, users can use the Weak element to mark content items and then use Discovery to view the use frequency and end user messages matched for each content item. This is particularly useful for analyzing the usage of content items with wildcards, which typically cannot give exact replies.

Additional feature of the Weak Element: The Weak element can also improve conversation quality when the user inputs multiple sentences to system. The system splits such a multiple input message into separate and distinct sentences, processes each sentence in sequence, and thus gets multiple outputs.

Before outputs are sent to the end user, the system filters out weak outputs (outputs that contain Weak elements) to improve the conversation quality as follows:—If there are one or more outputs without Weak elements, the output without Weak elements are retained while the output with Weak elements are dropped;—If all outputs have Weak elements, only one of the outputs are kept. A random output or a first or last output can be chosen.

Unlike traditional systems that return all outputs without considering their quality, the present disclosure provides reliable response at a higher priority and drops weak elements. In this manner, user experience is considerably improved.

Developers may user a pair of <weak> and </weak> to wrap the whole weak output as follows: <weak>Gland to know that</weak> although this implementation is optionally because other methods may be used to separate output from each other. In addition, this feature is helpful for the situation that user input contains a single sentence by system splits it into two, as follows:

I am tall and thin

=> I am tall.
=> I am thin.

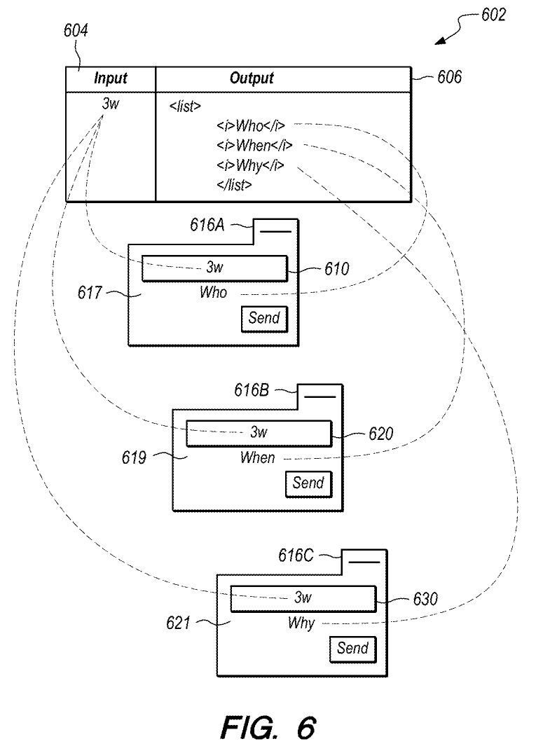

FIG. 6 shows cell 602 and chatbot dialog interface 616A, chatbot dialog interface 616B and chatbot dialog interface 616C of chatbot server system 108 (FIG. 1) that illustrate the List element in accordance with an exemplary embodiment of the present disclosure.

In FIG. 6, cell 602 and chatbot dialog interfaces 616A, 616B and 616C illustrate an instance of the List language element, which in one embodiment is an extension of AIML. The List language element returns items on a list one after the other while automatically creating and maintaining pointers for the list element. Specifically, the List element can be used to provide users with a set of messages without duplicates such as when the user is taking a quiz and the chatbot is programmed to avoid asking the same question twice.

Unlike traditional systems that require users to define a variable as a pointer in order for a chatbot to return items on a list, the present disclosure automatically maintains pointers so that users do not need to work with pointers. The syntax for the List element is as follows:

<list>

<i>item 1</i>
<i>item 2</i>
<i>...</i>

</list>
<list name=“name”>

```
  <i>item 1</i>
<i>item 2</i>
  <i>...</i>
```

</list>

The list name is optional. Referring now to FIG. 6, cell 602 includes input 604 and output 606 that are stored in knowledge database 150. Input 604 stores the pattern “3w” while output 506 stores the corresponding template:

<list>

<i>Who</i>
<i>When</i>
<i>Why</i>

</list>

As shown in chatbot dialog interface 616A, the user begins by entering the input message “3w” shown in dialog box 610 to which the chatbot responds “Who” as shown in chatbot output display 617. Next, in chatbot dialog interface 616B, the user again enters the input message “3w” shown in dialog box 620 to which the chatbot responds “When” as shown in chatbot output display 619. Finally, in chatbot dialog interface 616C, the user again enters the input message “3w” shown in dialog box 630 to which the chatbot responds “Why” as shown in chatbot output display 621.

In operation, a program is provided that creates a unique ID for each List instance. This unique ID may be created by using the content ID where the list used (if each content can only has one List element) or maintains a variable to store the ID for the last List. As is conventional, where the cells (content items) are stored in a database, the database system automatically assigns a unique ID for each cell.

Such ID can be used to name the pointer variables for List language or (Rand language) elements, which require unique IDs. Where a cell contains more than one Rand element or List element, the system may create the unique IDs for each element by appending additional identification to the cell ID. Alternatively, system may use the combination of cell input and context, which is unique within the knowledge base, to replace the cell ID. Alternatively, system may maintain a serial number for Rand/List language element. When user creates a cell, the system automatically obtains the next serial number and add a name/id attribute to the language element. For example, Rand might be:

<rand id=‘1234’>

<i>item 1</i>
<i>item 2</i>
<i>...</i>

</rand>

As noted, the system generates a unique variable for each Rand or List element, without user's involvement.

When the chatbot dialog interface 616A receives the statement “3w” via dialog box 610, chatbot server system 108 matches the pattern with input 604, which is paired with the output 606 template.

Here, the program uses the unique ID above to identify the value of pointer, which indicates which item to return upon request. In this case, the item to return is “Who” in chatbot output display 617. The program then increases the count of the pointer by one when for the returned item “Who” and subsequently returned items on the list. In an alternative embodiment, the program may provide a default item when the end of list is reached. In a further embodiment, the program may allow users to name a list with an attribute or parameter. Preferably, the names are unique within the whole knowledge database. Where a name is provided, the program might use the name to identify the pointer for the list.

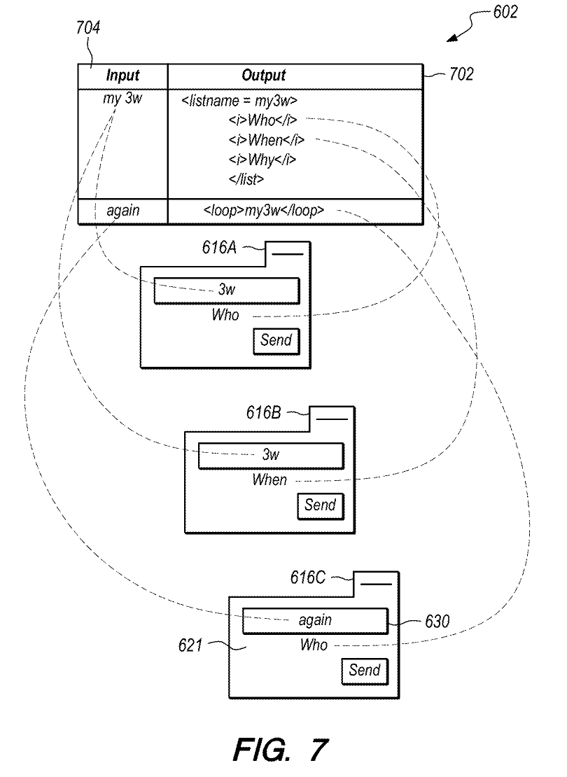

FIG. 7 shows cell 602 and chatbot dialog interface 616A, chatbot dialog interface 616B and chatbot dialog interface 616C of chatbot server system 108 (FIG. 1) that illustrate the Loop element in accordance with an exemplary embodiment of the present disclosure.

In FIG. 7, cell 602 and chatbot dialog interfaces 616A, 616B and 616C illustrate an instance of the Loop language element, which in one embodiment is an extension of AIML. The List element allows users to name and then loop a list without working with a pointer. Unlike traditional systems that require users to define a variable as a pointer in order to implement a loop structure, the present disclosure automatically maintains pointers so that users do not need to work with pointers. The syntax for the Loop element is as follows:

<list name=“name”>

```
  <i>item 1</i>
<i>item 2</i>
  <i>...</i>
```

</list>
<loop>name</loop>

The Loop element is used along with a named list. The loop element can be placed in a cell other than one that defines list.

In FIG. 7, chatbot server system 108 is as and operates in a similar manner as the List element described with reference to FIG. 6, except that the Loop element is employed in addition to the List element. Specifically, output 702 stores the List element template: <loop> my3w</loop> while its corresponding input message “again” is stored in input 704. When a user enters the input message “again” as shown in dialog box 630 of FIG. 7, the chatbot responds by looping and returning the first item on the named list, in this case, “who” as shown by chatbot output display 621.

AI as Converter—the present disclosure uses a chatbot as a converter to provide the conversion or mapping function from one string to another. Unlike traditional systems that use a list of simple text pair to map from one string to another, the present disclosure employs a chatbot for the conversion. As an example, a chatbot might be employed for a country/capital conversion having a list of country names and corresponding capital city name like: USA/Washington D.C., China/Beijing. AI as converter enables system to implement more complex functionality that facilitates performance improvements.

System Details

Further details of a system suitable for performing the method described above will now be described in more detail.

The processor of processor 140 is arranged to perform the steps of a program stored as program instructions within the memory device. The program instructions enable the various methods of performing the invention as described herein to be performed. The program instructions, may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium.

The processor 140 is also configured to be able to sort data and arrange this for visualisation, by utilising a data retrieval module that is in communication with the data storage systems or devices that form the knowledge database 150.

It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein, and that certain modules or engines may be combined into single modules or engines.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system (for example, the system could be built using Ruby on Rails with Node.js). Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose computing system specifically programmed to perform the described steps. Alternatively, the methods described herein may be implemented using a specific computer system such as a data sorting and visualisation computer, a database query computer, a graphical analysis computer, a gaming data analysis computer, a manufacturing data analysis computer, a business intelligence computer etc., where the computer has been specifically adapted to perform the described steps on specific data captured from an environment associated with a particular field.

The system or apparatus may include one or more of the following: 1) a processor, 2) an installation mechanism, 3) a system interface and/or 4) a client interface. The method may include an operating and/or using any of the processor, the installation mechanism, the system interface and/or the client interface to capitalize on secondary attracted talent during a recruitment process.

A processor may include a computer and/or at least one finite state machine. The computer may include a data processor and an instruction processor with the data processors instructed by the instruction processor for use by one or more steps of the method's of operating and/or using the processor.

A finite state machine receives an input, may maintain and/or update one state and generates an output based upon one value of the input and/or the states. The installation mechanism may be configured, used and/or operated to interact with one of the processor(s), systems interface(s) and/or client interface(s) to configure the interacting processor, systems interface and/or client interface in accord with an aspect of this invention.

The configuration may be an installation package received and stored for a time by the processor, system interface and/or client interface. The installation package may alter a program system residing in a memory adapted to instruct the computer and/or alter programmable logic device(s) to operate the finite state machine. The programmable logic devices may include Field Programmable Gate Arrays (FPGAs) and/or programmable controllers. The installation mechanism may include implementations using a non-volatile memory to retain the installation package and/or a server to deliver the installation package.

The system interface may include a processor which in one embodiment is configured to support execution of the AIML language element extension elements. The client interface may include a processor configured to interact with the system interface and/or one or more of the previously mentioned processors. The client interface may be directed by a user activating the password protected access to capitalize on the secondary attracted talent during the recruitment process.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information.

A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/figures should be considered only as exemplary, and not limiting, unless otherwise specifically noted.

Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method, operable by a chatbot having a processor, an interactive dialog interface, and a knowledge database based at least in part on one or more extension language elements , the method comprising:
receiving via the interactive dialog interface, at least one or more characters of a user input message; and
responsive to the user input message, using the chatbot processor to generate an output message that is based on at least one extension language element,
wherein the output message is processed only a) when the at least one or more characters of the user input message can be no more than either numeric text or words that can be converted to numeric text, or b) if priority of context after the user input message can be dynamically increased or decreased on the fly.

2. The method of claim 1 wherein the output message is processed only when the at least one or more characters of the user input message can be no more than a predetermined number of words.

3. The method of claim 1 wherein the output message is processed only if previously returned indexes are excluded from being candidates for random output messages provided in response to the user input message.

4. The method of claim 1 wherein for a list of items each of which is to be returned from an ordered list, the output message is processed only if a pointer is automatically created and maintained for the ordered list to sequentially return each item in the ordered list.

5. The method of claim 4 wherein the output message is processed only if the ordered list can be named and a pointer is automatically maintained for the ordered list.

6. The method of claim 1 wherein the output message is processed only if the input message includes a wildcard element which can be marked to track frequency of use content with the wildcard element.

7. The method claim 1 wherein the output message is processed only if a separate processor instance is used for mapping one set of strings to another set.

8. The method of claim 1 wherein the output message is processed by a separate processor instance.

9. The method of claim 2 wherein the output message is processed by a separate processor instance.

10. The method of claim 1 wherein the output is processed only if the input message includes multiple sentences and at least one sentence includes a wildcard element which can be marked, wherein an output based on the sentence with the wildcard element is dropped while the output based on the sentence without a wildcard element is retained.

11. A method, operable by a chatbot having a processor, an interactive dialog interface, and a knowledge database based at least in part on one or more AIML (Artificial Intelligence Markup Language) extension language elements, the method comprising:
receiving via the interactive dialog interface, at least one or more characters of a user input message; and
responsive to the user input message, using the chatbot processor to generate an output message that is based on at least one language element that is an extension of AIML,
wherein the output message is processed only when the at least one or more characters of the user input message can be no more than either numeric text or words that can be converted to numeric text.

12. A method, operable by a chatbot having a processor, an interactive dialog interface, and a knowledge database based at least in part on one or more extension language elements , the method comprising:
receiving via the interactive dialog interface, at least one or more characters of a user input message; and
responsive to the user input message, using the chatbot processor to generate an output message that is based on at least one extension language element,
wherein the output message is processed:
when the at least one or more characters of the user input message can be no more than either numeric text or words that can be converted to numeric text, or b) if priority of context after the user input message can be dynamically increased or decreased on the fly;
when the at least one or more characters of the user input message can be no more than a predetermined number of words;
if previously returned indexes are excluded from being candidates for random output messages provided in response to the user input message;
wherein for a list of items each of which is to be returned from an ordered list, the output message is processed only if a pointer is automatically created and maintained for the ordered list to sequentially return each item in the ordered list;
if the ordered list can be named and a pointer is automatically maintained for the ordered list;
if the input message includes a wildcard element which can be marked to track frequency of use content with the wildcard element;
if a separate processor instance is used for mapping one set of strings to another set;
wherein the output message is processed by a separate processor instance;
wherein the output message is processed by a separate processor instance; or
if the input message includes multiple sentences and at least one sentence includes a wildcard element which can be marked, wherein an output based on the sentence with the wildcard element is dropped while the output based on the sentence without a wildcard element is retained.

13. The method of claim 1 wherein the extension language element that creates a separate instance of processing on which wildcard processing and mapping of string to string is based.
